(19) United States
(12) Patent Application Publication
(10) Pub. No.: US 2025/0035066 A1
(43) Pub. Date: Jan. 30, 2025

(54) A SYSTEM AND A METHOD FOR CONTROLLING THE POWER OUTPUT OF A STIRLING ENGINE

(71) Applicant: EnergyIntel Services Ltd., Nicosia (CY)

(72) Inventors: Martin Nilsson, Nicosia (CY); Karin Kjellin, Nicosia (CY)

(73) Assignee: EnergyIntel Services Ltd., Nicosia (CY)

(21) Appl. No.: 18/713,797

(22) PCT Filed: Nov. 25, 2022
(86) PCT No.: PCT/SE22/51099

§ 371 Date: May 28, 2024

(30) Foreign Application Priority Data
Dec. 20, 2021 (SE) 2151556-4

(51) Int. Cl. F02G 1/045

(52) U.S. Cl. CPC F02G 1/045; F02G 1/06; F02G 2243/30

(57) ABSTRACT

A system for controlling the power output of a Stirling is provided that includes a hot heat source and a cold heat sink. A control unit receives a first temperature signal representative of a measured temperature of the hot heat source and a second temperature signal representative of a measured temperature of the cold heat sink. A look-up table provides a representation of the power output as a function of the mean engine pressure, pie, and the operating frequency, ƒ, of the Stirling engine. The values of the power output in the look-up table have been determined for predefined temperatures of the hot heat source and the cold heat sink. The control unit is configured to, based on the received temperature signals, recalculate the values of the power output and update the look-up table accordingly, and to control the power output by controlling the mean engine pressure, pie, and the operating frequency, ƒ, based on the updated look-up table. A method of controlling the power output of a Stirling engine is also provided.

### TECHNICAL FIELD

The present disclosure relates to a system for controlling the power output of a Stirling engine. The present disclosure also relates to a method for controlling the power output of a Stirling engine. Furthermore, the present disclosure relates to a control unit for controlling the power output of a Stirling engine.

### BACKGROUND ART

Thermal energy can be converted into electrical energy in several ways. Some systems use Stirling engines as a generator to convert thermal energy to electrical energy. Stirling engines are closed-cycle engines which use an external heat source to expand a working gas which drives one or more pistons.

Furthermore, Stirling engines in combination with a thermal energy storage can be used to utilize excess power from e.g. photovoltaic power plants and wind turbines. Instead of curtailing the power when the output of such power plants exceeds electricity demand, the excess power is used to, for instance, charge the thermal energy storage, thus making it possible to later draw energy from said storage when demand for electricity exceeds available output from these intermittent renewable sources. It is then possible to use a Stirling engine to convert the thermal energy to electricity.

Power modulation in Stirling engines is commonly performed by changing the mean pressure of the working gas or by altering the frequency of the piston. However, simply controlling these two parameters may not result in an accurate enough power output.

### SUMMARY OF THE INVENTION

An object of the present disclosure is to provide a system and a method which at least partly alleviate the drawbacks of the prior art. This and other objects, which will become apparent in the following discussion, are achieved by a system and a method according to the accompanying independent claims. Exemplary embodiments are presented in the dependent claims.

The inventors have realized that, in addition to the internal working gas pressure and the frequency, the thermodynamic nature of a Stirling engine also has effect on the power output. In particular, the inventors have realized that the power output also depends on the boundary temperatures of the Stirling engine, i.e. the temperatures of the hot heat source and the cold heat sink, respectively. By taking known power outputs based on certain pressure-frequency combinations, at known temperatures of the hot heat source and the cold heat sink, and by then doing a rescaling/recalculation based on actually measured current temperatures of the hot heat source and the cold heat sink, a better accuracy may be achieved when controlling the power output of the Stirling engine. In other words, according to the present disclosure you may start from a template which is based on known temperature conditions and then recalculate it based on current temperature conditions. This will now be discussed in more detail below.

According to a first aspect of the present disclosure, there is provided a system for controlling the power output of a Stirling engine, the Stirling engine comprising a hot heat source and a cold heat sink, the system comprising:
a first temperature sensor configured to measure a current temperature of the hot heat source and to generate a first temperature signal representative of the measured current temperature of the hot heat source,
a second temperature sensor configured to measure a current temperature of the cold heat sink and to generate a second temperature signal representative of the measured current temperature of the cold heat sink,
a control unit configured to receive the generated first temperature signal and the generated second temperature signal,
a look-up table electronically stored in the control unit or accessible by the control unit, wherein the look-up table provides a representation of the power output as a function of the mean engine pressure, pme, and the operating frequency, ƒ, of the Stirling engine, wherein the values of the power output in the look-up table have been determined for predefined first and second reference temperatures of the hot heat source and the cold heat sink, respectively, wherein the control unit is configured to:
based on the received first and second temperature signals, recalculate the values of the power output and update the look-up table with the recalculated values, and
control the power output of the Stirling engine by controlling the mean engine pressure, pme, and the operating frequency, ƒ, of the Stirling engine based on the updated look-up table.

By recalculating the values of the power output based on the current measured temperature, a more accurate control of the power output of the Stirling engine is achieved.

When subsequently controlling the power output of the Stirling engine, depending on the desired output value, the control unit may, based on the updated look-up table, select or suggest a mean engine pressure, pme, and an operating frequency, ƒ. The mean engine pressure, pme, is the average of the working pressure for one full cycle of the Stirling engine. The working pressure may be measured by means of a pressure sensor. The operating frequency is a measure of the speed of a full cycle.

The look-up table may be stored on any suitable storage medium. Such a storage medium may also comprise persistent storage, which, for example may be any single one or combination of magnetic memory, optical memory, solid state memory or even remotely mounted memory.

The control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where it includes a programmable device such as the microprocessor, microcontroller or programmable digital signal processor mentioned above, the processor may further include computer executable code that controls operation of the programmable device. The control unit may communicate via an interface, e.g. with the sensors disclosed herein and with other components of the Stirling engine, such as linear motors/generators (or with any other types of motors, such as motors provided with crankshafts and rotating generators). As such, the interface may comprise one or more transmitters and receivers, comprising analogue and digital components and a suitable number of ports for wireline or wireless communication.

According to at least one exemplary embodiment, the control unit is configured to recalculate the values of the power output in the look-up table based on the following equation:

$$\frac{Pout , ref}{Pout , new} = {( \frac{Th , ref}{Th , current} )}^{bh} \cdot {( \frac{Tc , ref}{Tc , current} )}^{bc}$$

where
   Pout,ref is a present value of the power output in the look-up table,
   Pout,new is the recalculated value of the power output,
   Th,ref is the first reference temperature,
   Th,current is the measured current temperature of the hot heat source,
   Tc,current is the measured current temperature of the cold heat sink,
   Tc,ref is the second reference temperature,
   bh is a function of Th,current, Th,ref, and the frequency ƒ and mean engine pressure pme associated with Pout,ref,
   bc is a function of Tc,current, Tc,ref, and the frequency ƒ and mean engine pressure pme associated with Pout,ref.

Since each power output, Pout,ref, has an associated frequency, ƒ, and an associated mean engine pressure, pme, for the given reference temperatures, Th,ref and Tc,ref, in the present look-up table, and since the current temperatures, Th,current and Tc,current, have now been measured, all variables are known except for Pout,new which can now be calculated by using the above equation. Thus, by using said equation for each present value of the power output, Pout,ref, in the present form of the look-up table, that power output, Pout,ref, can be replaced by new respective recalculated values of the power output, Pout,new, whereby the look-up table becomes updated with more accurate values that better reflect the actual temperature conditions.

According to at least one exemplary embodiment, the functions bh and bc are defined as follows:

$$bh = {C}_{0 h} + {C}_{1 h} \cdot {T}_{h , current} / {T}_{h , ref} + {C}_{2 h} \cdot n \cdot pme$$

$$bc = {C}_{0 c} + {C}_{1 c} \cdot {T}_{c , current} / {T}_{c , ref} + {C}_{2 c} \cdot n \cdot pme ,$$

where C₀ₕ, C₁ₕ, C₂ₕ, C_{0c}, C_{1c}, C_{2c} are constants.

The values of the various constants may suitably be selected by means of the least-squares method, e.g. based on data from tests or calculation models.

According to at least one exemplary embodiment, the control unit is configured to receive a power output request representative of a value of a desired power output for the Stirling engine. Such a power request may come from a manual input by an operator, or from an automatic regulating system or in any other appropriate way. The control unit may thus control the power output, using the updated look-up table, to select or suggest a frequency and a mean engine pressure that matches the power output request.

In case the power output request includes a value that is not present in the updated look-up table, then the control unit may use a suitable control strategy which adapts to this discrepancy.

Thus, according to at least one exemplary embodiment, the control unit is configured to receive a power output request representative of a value of a desired power output for the Stirling engine, wherein if said value of a desired power output is not present in the updated look-up table, then the control unit is configured to identify the nearest neighbouring value and to select or suggest the frequency and the mean engine pressure associated with the identified nearest neighbouring value in order for the Stirling engine to provide a power output close to the desired power output. This is advantageous, as it provides a simple way to control the power output. Furthermore, although the control unit will not use the desired power output, but a value which is close to the desired power output, this still provides a more accurate control because of the updated look-up table, compared to traditional prior art power control. Nevertheless, if the “nearest neighbour” strategy is not considered to be fully satisfactory, other strategies may be used, such as using interpolation. This is at least partly reflected in the following exemplary embodiment.

Thus, according to at least one exemplary embodiment, the control unit is configured to receive a power output request representative of a value of a desired power output for the Stirling engine, wherein if said value of a desired power output is not present in the updated look-up table, then the control unit is configured to perform an interpolation based on available values in the updated look-up table, and to select or suggest a frequency and a mean engine pressure based on the interpolation in order for the Stirling engine to substantially provide the desired power output. By using interpolation in combination with the updated look-up table, an even more accurate power control is achievable.

According to a second aspect of the present disclosure, there is provided a method for controlling the power output of a Stirling engine, the Stirling engine comprising a hot heat source and a cold heat sink, the method comprising:
receiving a first temperature signal representative of a measured current temperature of the hot heat source,
receiving a second temperature signal representative of a measured current temperature of the cold heat sink,
accessing an electronically stored look-up table, wherein the look-up table provides a representation of the power output as a function of the mean engine pressure, pme, and the operating frequency, ƒ, of the Stirling engine, wherein the values of the power output in the look-up table have been determined for predefined first and second reference temperatures of the hot heat source and the cold heat sink, respectively,
recalculating, based on the received first and second temperature signals, the values of the power output,
updating the look-up table with the recalculated values, and
controlling the power output of the Stirling engine by controlling the mean engine pressure, pme, and the operating frequency, ƒ, of the Stirling engine based on the updated look-up table.

The advantages of the method of the second aspect largely correspond to the advantages of the system of the first aspect, including any embodiment thereof. Furthermore, the method of the second aspect may suitably be used when operating a system of the first aspect.

Conversely, the system of the first aspect may suitably be used when performing the method of the second aspect. Some exemplary embodiments of the method of the second aspect will be briefly listed below.

According to at least one exemplary embodiment of the method, said step of recalculating comprises recalculating the values of the power output in the look-up table based on the following equation:

$$\frac{Pout , ref}{Pout , new} = {( \frac{Th , ref}{Th , current} )}^{bh} \cdot {( \frac{Tc , ref}{Tc , current} )}^{bc}$$

where
   Pout,ref is a present value of the power output in the look-up table,
   Pout,new is the recalculated value of the power output,
   Th,ref is the first reference temperature,
   Th,current is the measured current temperature of the hot heat source,
   Tc,current is the measured current temperature of the cold heat sink,
   Tc,ref is the second reference temperature,
   bh is a function of Th,current, Th,ref, and the frequency ƒ and mean engine pressure pme associated with Pout,ref,
   bc is a function of Tc,current, Tc,ref, and the frequency ƒ and mean engine pressure pme associated with Pout,ref.

According to at least one exemplary embodiment of the method, the functions bh and bc are defined as follows:

$$bh = {C}_{0 h} + {C}_{1 h} \cdot {T}_{h , current} / {T}_{h , ref} + {C}_{2 h} \cdot n \cdot pme$$

$$bc = {C}_{0 c} + {C}_{1 c} \cdot {T}_{c , current} / {T}_{c , ref} + {C}_{2 c} \cdot n \cdot pme ,$$

where C₀ₕ, C₁ₕ, C₂ₕ, C_{0c}, C_{1c}, C_{2c} are constants.

According to at least one exemplary embodiment, the method further comprises:
receiving a power output request representative of a value of a desired power output for the Stirling engine,
wherein if said value of a desired power output is not present in the updated look-up table, then the nearest neighbouring value is identified and the frequency and the mean engine pressure associated with the identified nearest neighbouring value is selected or suggested in order for the Stirling engine to provide a power output close to the desired power output.

According to at least one exemplary embodiment, the method further comprises:
receiving a power output request representative of a value of a desired power output for the Stirling engine,
wherein if said value of a desired power output is not present in the updated look-up table, then an interpolation is performed based on available values in the updated look-up table, and a frequency and a mean engine pressure to is selected or suggested based on the interpolation in order for the Stirling engine to substantially provide the desired power output.

According to a third aspect of the present disclosure, there is provided a control unit for controlling the power output of a Stirling ending which comprises a hot heat source and a cold heat sink, the control unit being configured to perform the steps of the method according to the second aspect, including the steps in any embodiment thereof. The control unit may suitably be a control unit as disclosed in connection with the system of the first aspect. Furthermore, the advantages of the control unit of the third aspect are largely analogous with the advantages of the system of the first aspect and the method of the second aspect, including any embodiment thereof.

Further features of, and advantages with, the present disclosure will become apparent when studying the appended claims and the following description. The skilled person realize that different features of the present disclosure may be combined to create embodiments other than those described in the following, without departing from the scope of the present disclosure.

### BRIEF DESCRIPTION OF THE DRAWINGS

The above, as well as additional objects, features and advantages of the present disclosure, will be better understood through the following illustrative and non-limiting detailed description of exemplary embodiments of the present invention, wherein:

FIG. 1 illustrates very schematically a system according to at least one exemplary embodiment of the present disclosure.

FIG. 2 illustrates a method according to at least one exemplary embodiment of the present disclosure.

### DETAILED DESCRIPTION

The present disclosure will now be described more fully hereinafter with reference to the accompanying drawings, in which exemplary embodiments are shown. The illustrated system and method may, however, be embodied in many different forms and should not be construed as limited to the embodiments set forth herein; rather, these embodiments are provided for thoroughness and completeness.

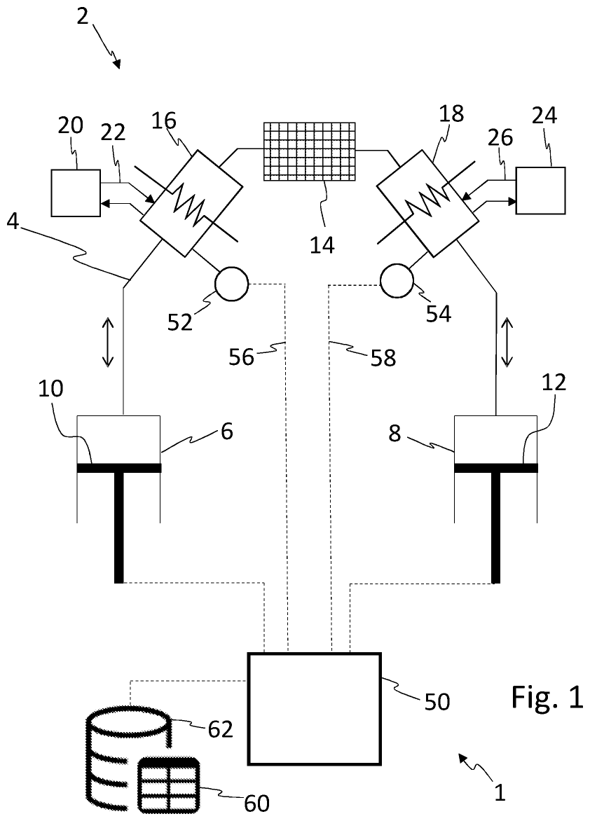

FIG. 1 illustrates very schematically a system 1 according to at least one exemplary embodiment of the present disclosure. The system 1 is used for controlling the power output of a Stirling engine 2.

The Stirling engine 2 comprises a working gas channel 4 which fluidly interconnects a first cylinder 6 and a second cylinder 8. The first cylinder 6 has a first piston 10 which performs a reciprocating movement within the first cylinder 6. Similarly, the second cylinder 8 has a second piston 12 performing a reciprocating movement within the second cylinder 8. The working gas within the working gas channel 4 will be displaced back and forth due to the reciprocating movements of the first and second pistons 10, 12. A regenerator 14 is provided at the working gas channel 4. Such regenerators are well known per se in Stirling engines, and will therefore not be discussed in more detail in this disclosure.

The Stirling engine 2 also comprises a heater 16 and a cooler 18. From a fluid path perspective, the first cylinder 6 and the heater 16 are provided on one side of the regenerator 14, while the second cylinder 8 and the cooler 18 are provided on another side of the regenerator 14. Thus, the first cylinder 6 may be regarded as the “hot cylinder”, while the second cylinder 8 may be regarded as the “cold cylinder”. The working gas in the working gas channel 4 will thus be heated by the heater 16 and will be cooled by the cooler 18. These will be discussed in more detail further down in this disclosure.

The system 1 comprises a control unit 50. The system also comprises a first temperature sensor 52 and a second temperature sensor 54 which generate first and second temperature signals 56, 58 that are received by the control unit 50. The system 1 further comprises a look-up table 60 electronically stored in the control unit 50 or accessible by the control unit 50. In FIG. 1 the look-up table is, e.g. illustrated as being stored in an external database 62, however, in other exemplary embodiments it may be stored in an internal memory of the control unit 50.

The look-up table 60 provides a representation of the power output as a function of the mean engine pressure, pme, and the operating frequency, ƒ, of the Stirling engine 2, wherein the values of the power output in the look-up table 60 have been determined for predefined first and second reference temperatures of a hot heat source and a cold heat sink, respectively, of the Stirling engine 2.

Below is an example of such a look-up table, illustrating how different combinations of the mean engine pressure and the operating frequency have resulted in different power outputs (at said reference temperatures).

Example: Illustration of look-up table showing a representation of the power output, Pout,ref, in dependence of varying values of the operating frequency, ƒ, and the mean engine pressure, pme, at a certain first reference temperature and a certain second reference temperature of the hot heat source and the cold heat sink, respectively.

| | Frequency | Pressure | Power output |
|---|---|---|---|
| | f | pme | Pout, ref |
| | (Hz) | (bar) | (W) |
| 1 | 20.833 | 50 | 3100 |
| 2 | 21.667 | 75 | 5200 |
| 3 | 23.333 | 75 | 5600 |
| 4 | 23.333 | 100 | 7600 |
| 5 | 23.333 | 115 | 8600 |
| 6 | 23.667 | 115 | 8700 |
| 7 | 24.000 | 115 | 8800 |
| 8 | 24.333 | 115 | 8900 |
| 9 | 24.667 | 115 | 9000 |
| 10 | 25.000 | 115 | 9100 |
| 11 | 25.417 | 115 | 9200 |
| 12 | 25.833 | 125 | 10000 |
| 13 | 25.667 | 125 | 10200 |
| 14 | 27.500 | 125 | 10400 |
| 15 | 29.167 | 125 | 10500 |
| 16 | 29.167 | 125 | 10700 |
| 17 | 30.000 | 125 | 10900 |
| 18 | 30.000 | 125 | 11000 |
| 19 | 31.667 | 125 | 11200 |
| 20 | 32.500 | 125 | 11300 |
| 21 | 32.500 | 135 | 11900 |
| 22 | 33.333 | 135 | 12000 |

According to the present disclosure, in order to enable a more accurate power modulation, the look-up table is updated to current temperature conditions.

Therefore, the first temperature sensor 52 is configured to measure a current temperature of the hot heat source of the Stirling engine 2. In the present illustration, the hot heat source is represented by the heater 16 itself. Thus, the first temperature sensor 52 is connected to the heater 16. However, in other exemplary embodiments, the hot heat source may be represented by some other components which are operatively connected to the heater 16. For instance, as illustrated in FIG. 1, the heater 16 may form a closed heating fluid circuit with a thermal energy storage 20, wherein the first temperature sensor 52 may suitably be connected to a conduit 22 leading the heating fluid from the thermal energy storage 20 to the heater 16. In such case, said conduit 22 would represent said hot heat source. It should, however, be understood that, in order for the recalculation of the values in the lookup-table 60 to be accurate, the same hot heat source should be measured upon as the hot heat source that was used for registering the first reference temperature on which the look-up table 60 is based.

Similarly, the second temperature sensor 54 is configured to measure a current temperature of the cold heat sink of the Stirling engine 2. In the present illustration, the cold heat sink is represented by the cooler 18 itself. Thus, the second temperature sensor 54 is connected to the cooler 18. However, in other exemplary embodiments, the cold heat sink may be represented by some other components which are operatively connected to the cooler 18. For instance, as illustrated in FIG. 1, the cooler may be connected to a cooling circuit 24, wherein the second temperature may suitably measure the temperature of a cooling fluid flowing in the cooling circuit 24, in particular in a conduit 26 leading to the cooler, or the temperature of the conduit 26 itself. In such case, said conduit 26 would represent the cold heat sink. In still other exemplary embodiments, the cold heat sink may even be the ambient temperature. Similarly to the temperature measurements at the hot heat source, it should be understood that the same cold heat sink should be used for measuring the current temperature as used for the reference temperature.

From the above it should now be understood that the first temperature sensor 52 is configured to measure a current temperature of the hot heat source (here represented by the heater 16) and to generate a first temperature signal 56 representative of the measured current temperature of the hot heat source. Correspondingly, the second temperature sensor 54 is configured to measure a current temperature of the cold heat sink (here represented by the cooler 18) and to generate a second temperature signal 58 representative of the measured current temperature of the cold heat sink.

Based on the received first and second temperature signals 56, 58, the control unit 50 is configured to recalculate the values of the power output and update the look-up table 60 with the recalculated values. Once the look-up table 60 has been recalculated, an accurate power control under the current temperature conditions may be achieved. Accordingly, the control unit 50 is configured to control the power output of the Stirling engine 2 by controlling the mean engine pressure, pme, and the operating frequency, ƒ, of the Stirling engine 2 based on the updated look-up table 60. FIG. 1 schematically illustrates this as the control unit 50 controlling the movements of the first and second pistons 10, 12. In practice, the control unit 50 may suitably be connected to any suitable type of motors, such as for instance linear motors/generators, which in turn are connected to the pistons 10, 12. Thus, the control unit 50 may control the operation of the linear motors/generators to obtain the desired operating frequency and mean engine pressure. The control unit 50 adjusts the operating frequency by controlling the speed of the pistons 10, 12. The mean engine pressure may be controlled by a pressurization arrangement (not illustrated in the drawings), e.g. including a compressor, wherein the control unit 50 may control the operation of such a pressurization arrangement in order to adjust the mean engine pressure.

The control unit 50 may suitably use the following equation for recalculating the values of the power output in the look-up table 60:

$$\frac{Pout , ref}{Pout , new} = {( \frac{Th , ref}{Th , current} )}^{bh} \cdot {( \frac{Tc , ref}{Tc , current} )}^{bc}$$

where
   Pout,ref is a present value of the power output in the look-up table,
   Pout,new is the recalculated value of the power output,
   Th,ref is the first reference temperature,
   Th,current is the measured current temperature of the hot heat source,
   Tc,current is the measured current temperature of the cold heat sink,
   Tc,ref is the second reference temperature,
   bh is a function of Th,current, Th,ref, and the frequency ƒ and mean engine pressure pme associated with Pout,ref,
   bc is a function of Tc,current, Tc,ref, and the frequency ƒ and mean engine pressure pme associated with Pout,ref.

The functions bh and bc may suitably be defined as follows:

$$bh = {C}_{0 h} + {C}_{1 h} \cdot {T}_{h , current} / {T}_{h , ref} + {C}_{2 h} \cdot n \cdot pme$$

$$bc = {C}_{0 c} + {C}_{1 c} \cdot {T}_{c , current} / {T}_{c , ref} + {C}_{2 c} \cdot n \cdot pme ,$$

where C₀ₕ, C₁ₕ, C₂ₕ, C_{0c}, C_{1c}, C_{2c} are constants.

The control unit 50 may be configured to receive a power output request representative of a value of a desired power output of the Stirling engine 2. If that value is not present in the updated look-up table 60, then the control unit 50 may interpolate the available values in order to select or suggest a frequency and a mean engine pressure in order for the Stirling engine 2 to substantially provide the desired power output. Alternatively, the control unit 50 may look for the nearest neighbouring value in the look-up table 60 and select or suggest the frequency and the mean engine pressure associated with the identified nearest neighbouring value in order for the Stirling engine 2 to provide a power output close to the desired power output.

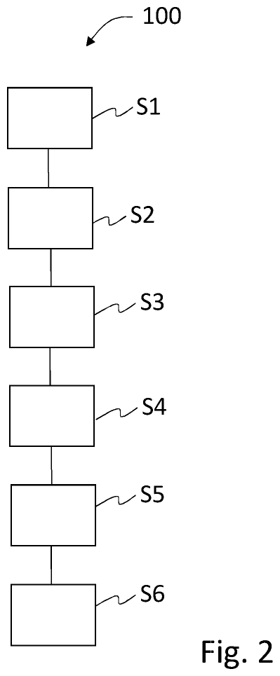

FIG. 2 illustrates a method 100 according to at least one exemplary embodiment of the present disclosure. In particular, FIG. 2 illustrates a method 100 for controlling the power output of a Stirling engine, the Stirling engine comprising a hot heat source and a cold heat sink, the method 100 comprising:
in a step S1, receiving a first temperature signal representative of a measured current temperature of the hot heat source,
in a step S2, receiving a second temperature signal representative of a measured current temperature of the cold heat sink,
in a step S3, accessing an electronically stored look-up table, wherein the look-up table provides a representation of the power output as a function of the mean engine pressure, pme, and the operating frequency, ƒ, of the Stirling engine, wherein the values of the power output in the look-up table have been determined for predefined first and second reference temperatures of the hot heat source and the cold heat sink, respectively,
in a step S4, recalculating, based on the received first and second temperature signals, the values of the power output,
in a step S5, updating the look-up table with the recalculated values, and
in a step S6, controlling the power output of the Stirling engine by controlling the mean engine pressure, pme, and the operating frequency, ƒ, of the Stirling engine based on the updated look-up table.

It should be understood that the steps S1-S6 do not necessarily need to be carried out in the listed sequence. For instance the steps S1 and S2 may be performed simultaneously or in any order. Similarly, step S3 may be performed substantially simultaneously with steps S1 and S2, or with a time difference.

1. A system (1) for controlling the power output of a Stirling engine (2), the Stirling engine comprising a hot heat source (16) and a cold heat sink (18), the system comprising:
a first temperature sensor (52) configured to measure a current temperature of the hot heat source and to generate a first temperature signal (56) representative of the measured current temperature of the hot heat source,
a second temperature sensor (54) configured to measure a current temperature of the cold heat sink and to generate a second temperature signal (58) representative of the measured current temperature of the cold heat sink,
a control unit (50) configured to receive the generated first temperature signal and the generated second temperature signal,
a look-up table (60) electronically stored in the control unit or accessible by the control unit, wherein the look-up table provides a representation of the power output as a function of the mean engine pressure, pme, and the operating frequency, ƒ, of the Stirling engine, wherein the values of the power output in the look-up table have been determined for predefined first and second reference temperatures of the hot heat source and the cold heat sink, respectively,
wherein the control unit is configured to:
based on the received first and second temperature signals, recalculate the values of the power output and update the look-up table with the recalculated values, and
control the power output of the Stirling engine by controlling the mean engine pressure, pme, and the operating frequency, ƒ, of the Stirling engine based on the updated look-up table.

2. The system (1) as claimed in claim 1, wherein the control unit (50) is configured to recalculate the values of the power output in the look-up table (60) based on the following equation:
$$\frac{Pout , ref}{Pout , new} = {( \frac{Th , ref}{Th , current} )}^{bh} \cdot {( \frac{Tc , ref}{Tc , current} )}^{bc}$$
Where
Pout,ref is a present value of the power output in the look-up table,
Pout,new is the recalculated value of the power output,
Th,ref is the first reference temperature,
Th,current is the measured current temperature of the hot heat source,
Tc,current is the measured current temperature of the cold heat sink,
Tc,ref is the second reference temperature,
bh is a function of Th,current, Th,ref; and the frequency ƒ and mean engine pressure pine associated with Pout,ref,
be is a function of Tc,current, Tc,ref, and the frequency ƒ and mean engine pressure pine associated with Pout,ref.

3. The system (1) as claimed in claim 2, wherein
$$bh = {C}_{0 h} + {C}_{1 h} \cdot {T}_{h , current} / {T}_{h , ref} + {C}_{2 h} \cdot n \cdot pme$$
$$bc = {C}_{0 c} + {C}_{1 c} \cdot {T}_{c , current} / {T}_{c , ref} + {C}_{2 c} \cdot n \cdot pme ,$$
where Cₒₕ, Cᵢₕ, C₂ₕ, C_{oc}, C_{ic}, C_{2c} are constants.

4. The system (1) as claimed claim 1, wherein the control unit (50) is configured to receive a power output request representative of a value of a desired power output for the Stirling engine (2), wherein if said value of a desired power output is not present in the updated look-up table (60), then the control unit is configured to perform an interpolation based on available values in the updated look-up table, and to select or suggest a frequency and a mean engine pressure based on the interpolation in order for the Stirling engine to substantially provide the desired power output.

5. The system (1) as claimed claim 1, wherein the control unit (50) is configured to receive a power output request representative of a value of a desired power output for the Stirling engine (2), wherein if said value of a desired power output is not present in the updated look-up table (60), then the control unit is configured to identify the nearest neighbouring value and to select or suggest the frequency and the mean engine pressure associated with the identified nearest neighbouring value in order for the Stirling engine to provide a power output close to the desired power output.

6. A method (100) for controlling the power output of a Stirling engine, the Stirling engine comprising a hot heat source and a cold heat sink, the method comprising:
receiving (S1) a first temperature signal representative of a measured current temperature of the hot heat source,
receiving (S2) a second temperature signal representative of a measured current temperature of the cold heat sink,
accessing (S3) an electronically stored look-up table, wherein the look-up table provides a representation of the power output as a function of the mean engine pressure, pme, and the operating frequency, ƒ, of the Stirling engine, wherein the values of the power output in the look-up table have been determined for predefined first and second reference temperatures of the hot heat source and the cold heat sink, respectively,
recalculating (S4), based on the received first and second temperature signals, the values of the power output,
updating (S5) the look-up table with the recalculated values, and
controlling (S6) the power output of the Stirling engine by controlling the mean engine pressure, pme, and the operating frequency, ƒ, of the Stirling engine based on the updated look-up table.

7. A control unit (50) for controlling the power output of a Stirling engine (2) which comprises a hot heat source (16) and a cold heat sink (18), the control unit being configured to perform the steps of the method (100) according to claim 6.
